(19) United States
(12) Patent Application Publication
(10) Pub. No.: US 2011/0284033 A1
(43) Pub. Date: Nov. 24, 2011

(54) CLEANING OF NATURAL GAS ASH DEPOSITS FROM COMBUSTION CHAMBERS

(76) Inventors: Patrick J. TAYLOR, Rancho Cordova, CA (US); Tim Eitzen, Walnut Creek, CA (US); David S. Lee, Benicia, CA (US); Michael J. Haire, Petaluma, CA (US)

(21) Appl. No.: 12/785,177

(22) Filed: May 21, 2010

(51) Int. Cl. B08B 7/00

(52) U.S. Cl. 134/19

(57) ABSTRACT

A method is provided for removing carbonaceous ash deposits from a light hydrocarbon gas combustion chamber. The method comprises contacting the gas combustion chamber containing the ash deposits with alkali metal hydroxide. The alkali metal hydroxide causes the ash to soften and in one embodiment, to flake off, often down to bare metal. The combustion chamber can be part of a spark-ignited engine run on natural gas or propane.

### FIELD OF THE INVENTION

This invention relates to removing ash deposits from a combustion chamber. More particularly, this invention relates to a method for removing natural gas ash deposits from a combustion chamber. The method involves the use of alkali metal hydroxide and avoids the need to disassemble the entire combustion chamber or engine for cleaning.

### DESCRIPTION OF THE RELATED ART

It is well known that automotive engines tend to form deposits on the surface of engine components, such as carburetor ports, throttle bodies, fuel injectors, intake ports and intake valves, due to oxidation and polymerization of hydrocarbon fuel. These deposits, even when present in relatively minor amounts, often cause noticeable drivability problems, such as stalling and poor acceleration. Moreover, engine deposits can significantly increase a vehicle's fuel consumption and production of exhaust pollutants.

The use of light hydrocarbon gases, such as natural gas and propane, to overcome the problems with using conventional gasoline internal combustion engines is becoming more popular. However, the use of light hydrocarbon gases such as natural gas in a combustion chamber does yield the creation of ash based deposits within the combustion chamber due to impurities in the gases. The accumulation of ash deposits within such combustion chambers e.g. natural gas engines, often causes problems with the combustion process, and subsequently the emissions can be negatively affected. The current solution to the accumulation of such deposits involves disassembling the engine and cleaning the parts by hand. This is quite cumbersome and time consuming. The ability to clean deposits without disassembling an entire combustion chamber or natural gas engine has the potential for a large amount of savings in terms of time and economics.

Accordingly, an object of the present invention is to provide a method for removing such ash deposits from a light hydrocarbon gas combustion chamber.

Another method of the present invention is to provide a method for removing low carbonaceous ash deposits from a light hydrocarbon gas combustion chamber without the need for disassembling the entire combustion chamber.

These and other objects of the present invention will become apparent upon a reading of the following specification and the claims appended thereto.

### SUMMARY OF THE INVENTION

Provided is a method for removing ash deposits from a light hydrocarbon gas combustion chamber, which method comprises contacting the gas combustion chamber with an alkali metal hydroxide. Alkali metal hydroxide is generally left in contact with the ash deposits for a length of time sufficient to cause the ash deposits to soften and in some cases begin to flake off down to bare metal. The chamber is then flushed to remove the ash deposits which have flaked off. The ash deposits are low carbonaceous ash deposits, often comprising siloxanes and metal compounds.

In one embodiment, the combustion chamber is a spark-ignited engine for a light hydrocarbon gas, such as natural gas or propane.

In another embodiment, the method comprises injecting alkali metal hydroxide solution into a natural gas engine while the engine is idling. After a length of time sufficient to cause the ash deposits to begin to flake, the engine is stopped. The engine oil is then drained from the engine to remove the alkali metal hydroxide and ash deposits.

Among other factors, it has been found that the use of alkali metal hydroxide can remove the ash deposits from a light hydrocarbon gas combustion chamber. In one embodiment, potassium hydroxide is especially useful in effecting a quick and effective removal of ash deposits created upon the burning of a light hydrocarbon gas, such as natural gas. Other hydroxide compounds do not react with the ash or effect a complete removal as does an alkali metal hydroxide. The alkali metal hydroxide causes the ash to soften and in one embodiment, to flake off down to bare metal. The use of alkali metal hydroxide thereby empowers one to clean ash deposits from within the combustion chamber of, for example, natural gas engines without disassembling the engine.

### DETAILED DESCRIPTION OF EMBODIMENTS

The light hydrocarbon gas which can be burned in a combustion chamber can be obtained from any available source. The light hydrocarbon gases can be comprised of any C₁-C₄ hydrocarbons. The light hydrocarbon gas may be comprised of natural gas, which is generally methane. Propane is also a gas often combusted.

The combustion chambers in which the light hydrocarbon gas is burned can be part of any gas application. Many exist for light hydrocarbons such as natural gas. For example, the combustion chamber can be in a power generator or it can be a spark-ignited engine. Such spark-ignited engines are often used in industrial vehicles such as buses or other large vehicles. Natural gas or another light hydrocarbon gas such as propane is employed as the fuel for combustion.

Natural gas or other light hydrocarbon gases can be obtained from any suitable source, many of which are known. These would include gas fields, methane gas from a landfill source or digester gas comprised of methane. While natural gas and methane are the light hydrocarbon gases often used, any gas comprised of a C₁-C₄ hydrocarbon can be used. For example, propane is another gas which can be burned in a spark-ignited engine or other combustion chamber.

The alkali metal hydroxide that is used in the present method is generally of a concentration ranging from 0.05 to 0.15M. In one embodiment, the concentration of the alkali metal hydroxide ranges from 0.05 to 0.1M. In another embodiment, the alkali metal hydroxide has a concentration of about 0.1M. It has been found that at these concentrations, alkali metal hydroxide can safely yet effectively remove the ash deposits. Compared to other hydroxides, only alkali metal hydroxides provide the quick and effective removal possible by the method of the present invention. A potassium hydroxide solution ranging from 0.056 to 0.15M is one embodiment.

A water based solution of alkali metal hydroxide is efffective; however, an oil based solution can also be used, particularly when high temperatures are involved.

When the alkali metal hydroxide solution comes in contact with the ash deposits and the combustion chamber, bubbling starts immediately. It is believed that the bubbles are methane bubbles. The ash begins to flake off of the combustion chamber walls. The ash flakes off to the base metal of the combustion chamber or engine. The alkali metal hydroxide remains in contact with the ash in the combustion chamber for a period of time effective to remove the ash. The time period may be from one to 12 hours, but is usually less than five hours and may be effective in the range from one to two hours.

The method involves contacting the gas combustion chamber having the ash with a solution comprising an alkali metal hydroxide. Alkali metal hydroxide maintains contact with the ash deposits for a length of time sufficient to cause the ash deposits to begin to flake. The chamber is then flushed to remove the ash deposits. The time period, as discussed above, can range from one to 12 hours, but the time period ultimately is dependent upon the concentration of the alkali metal hydroxide as well as the extent to which the ash is to be removed. Time periods of from one to two hours can be effective with an alkali metal hydroxide concentration of about 0.1M.

In one embodiment, the method comprises injecting an alkali metal hydroxide solution into the combustion chamber or engine while the engine is idling. The idle of the engine will be maintained at a no load idle, as the alkali metal hydroxide will slow down the firing of the engine. The injection of the alkali metal hydroxide solution is generally in the form of a fog or mist of alkali metal hydroxide solution. With the engine idling, the natural gas or other light hydrocarbon gas that continues to fire in the engine will help in the cleaning. It is both the thermal effect or heat created by the firing as well as the velocity or current of the gas which helps to clean the ash and remove it from the engine.

When the alkali metal hydroxide is to be injected into a hot engine, the use of an oil based solution can be used with good results. The oil based solution will not evaporate as quickly as a water based solution and therefore can be more effective in higher temperature environments. The solution used to inject the KOH into the engine may be comprised of any combination of the following mentioned components with or without water:

### Base Oils:

Mineral base oils that may be used include oils refined by a method consisting of a combination of reduced pressure distillation, solvent deasphalting, solvent extraction, solvent dewaxing, hydrogenation dewaxing, catalytic dewaxing, hydrocracking, washing with acid, or hydrofining. Synthetic hydrocarbon oils that may be used include oils such as alpha olefins, examples include: normal paraffins, isoparaffins, polybutenes, polyisobutylenes, or 1-decene oligomers; alkylated aromatics such as mono, di, and polyalkylated benzenes and naphthalenes; monoesters, diesters, polyesters, aromatic esters and polyolesters; polyglycols and polyalkylene glycols such as polyethylene glycol, polyethylene glycol monoether; polyphenyl ethers; tricresyl phosphates, silicone oils, or perfluoralkyl ethers.

### Additives:

Additives may also be used in the mixture. Components such as emulsifying agents, surfactants, dispersants, and detergents may be used.

Once the engine has been treated with the alkali metal hydroxide sufficiently, the engine can be stopped, and the engine oil drained from the engine to remove the alkali metal hydroxide and ash deposits from the engine. This method can be used in particular for an engine so that the engine does not have to be disassembled. However, the method can also be used on other combustion chambers which are located in power generators.

In another embodiment, the alkali metal hydroxide solution can simply be injected into a combustion chamber or engine. It is allowed to sit or work on the ash deposits for a sufficient length of time to have the flaking of the ash deposits finish. The same time intervals are appropriate. Once the ash has flaked off, which is generally down to bare metal, it is relatively easy to flush the combustion chamber to remove the ash deposits and any residual alkali metal hydroxide.

The ash deposits created by the burning of the light hydrocarbon gas, such as natural gas, often are the result of the combustion of gas in the presence of impurities. Such contaminants or impurities can comprise organic and inorganic compounds and can lead to engine deposits. These deposits are largely comprised of inorganic compounds, such as the salts, oxides, or phosphates of metals such as calcium. They can also contain siloxanes and metal compounds. These systems contain a portion of carbon, but it is generally less than ten weight percent of the deposits. In one embodiment less than 5 wt % of the deposits contain carbon.

The following examples are provided for illustration purposes, and are not meant to be limiting.

### Comparative Examples

Engine parts laden with ash deposits from natural gas combustion were soaked in water based solutions of potassium hydroxide, sodium hydroxide, ammonium hydroxide and calcium hydroxide to determine their effectiveness in removing the ash deposits. The results are below:

TABLE 1

| Hydroxide | Concentration | Time | Temperature | Result |
|---|---|---|---|---|
| KOH | 1M | 1 Min | 250 F. | Deposited ash slightly softened, but water |
| | | | | evaporated too quickly. |
| | 0.1M | 10 Min | 72 F. | Deposited ash significantly softened turning |
| | | | | deposit to mud like consistency which was |
| | | | | easily wiped clean. |
| | 0.1M | 10 Hrs | 72 F. | Deposited ash flaked off with light brushing |
| | | | | after sitting over night. |
| NaOH | 0.1M | 10 Min | 72 F. | Deposited ash was slightly softened |
| | 0.1M | 1 Min | 250 F. | No effect on the deposited ash |
| NH₄OH | 0.1M | 10 Min | 72 F. | No effect on the deposited ash |
| | 0.1M | 1 Min | 250 F. | No effect on the deposited ash |
| CA(OH)₂ | 0.1M | 10 Min | 72 F. | Deposited ash appeared slightly softened, but |
| | | | | not as much as for the NaOH. |
| | 0.1M | 1 Min | 250 F. | No effect on the deposited ash |

The foregoing results demonstrate that it is an alkali metal hydroxide alone that has any effect on the ash deposits. Potassium hydroxide, under the conditions indicated is particularly effective. Hydroxides other than alkali metal hydroxides have little or no effect on the ash deposits.

Having to describe the invention in detail, it would be understood that such detail need not be strictly adhered to, but that additional changes and modifications may suggest themselves to instill in the art, all falling within the scope of the invention as defined by the following claims.

What is claimed is:

1. A method for removing ash deposits from a light hydrocarbon gas combustion chamber, which comprises contacting the gas combustion chamber with alkali metal hydroxide.

2. The method of claim 1, wherein the alkali metal hydroxide maintains contact with the ash deposits for a length of time sufficient to cause the ash deposits to begin to flake, before flushing the chamber to remove the ash deposits.

3. The method claim 1, wherein the combustion chamber is comprised of a spark-ignited engine for a light hydrocarbon gas.

4. The method of claim 3, wherein the light hydrocarbon gas is comprised of C₁-C₄ hydrocarbons.

5. The method of claim 3, wherein the light hydrocarbon gas is comprised of natural gas.

6. The method of claim 3, wherein the method comprises injecting a solution of alkali metal hydroxide into the engine while the engine is idling, stopping the engine, and draining engine oil from the engine to remove the alkali metal hydroxide and ash deposits

7. The method of claim 1, wherein the alkali metal hydroxide concentration is from 0.05 to 0.15M.

8. The method of claim 1, wherein the combustion chamber is located in a power generator.

9. The method of claim 5, wherein the natural gas burned in the spark-ignited engine to create the ash deposits is comprised of methane.

10. The method of claim 9, wherein the methane is comprised of methane from a landfill source or from digester gas.

11. The method of claim 4, wherein the light hydrocarbon gas burned in the spark-ignited engine to create the ash deposits is comprised of propane.

12. The method of claim 1, wherein the ash deposits comprise less than 10 wt % carbon.

13. The method of claim 12, wherein the ash deposits comprise siloxanes and metal compounds.

14. The method of claim 6, wherein the alkali metal hydroxide is injected in the form of a water based solution.

15. The method of claim 6, wherein the alkali metal hydroxide is injected in the form of an oil based solution.

16. A method for cleaning the engine of a vehicle employing natural gas as a fuel with the engine having ash deposits in the carburetor, the method comprising
running the engine on idle;
injecting into the engine alkali metal hydroxide as a fog for a period of time sufficient to have the ash deposits begin to flake;
stopping the engine; and
draining engine oil from the engine to remove the alkali metal hydroxide and ash deposits.

17. The method of claim 16, wherein the alkali metal hydroxide concentration is at least about 0.1M.

18. The method claim 16, wherein the method is repeated at least a second time.

19. The method of claim 1, wherein the alkali metal hydroxide maintains contact with the ash deposits for a length of time sufficient to cause the ash deposits to soften.

20. The method of claim 1, wherein the alkali metal is potassium hydroxide.
